(19) United States
(12) Patent Application Publication
(10) Pub. No.: US 2005/0170726 A1
(43) Pub. Date: Aug. 4, 2005

(54) Multiple layer nonwoven products and methods for creating color schemes and for producing such products

(75) Inventors: Kevin K. Brunson, Aledo, TX (US); Darell S. Caldwell, Glen Rose, TX (US)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(73) Assignee: K.B. Aviation, Inc, d/b/a Brunson Associates, Aledo, TX (US)

(21) Appl. No.: 11/027,701

(22) Filed: Dec. 28, 2004

Related U.S. Application Data
(60) Provisional application No. 60/533,207, filed on Dec. 30, 2003.
(60) Provisional application No. 60/533,155, filed on Dec. 30, 2003.

(51) Int. Cl. B32B 5/26; D04H 1/00; D04H 3/00; B32B 7/00

(52) U.S. Cl. 442/327; 442/381; 428/212; 428/218; 442/361

(57) ABSTRACT

The present invention is related to colored nonwoven materials and more particularly to products formed, at least in part, from colored nonwoven materials and methods for creating color schemes in such products. The invention also includes methods of forming such colored nonwoven material.

### RELATIONSHIP TO PRIOR APPLICATIONS

This is a U.S. non-provisional application relating to and claiming the benefit of U.S. Provisional Patent Application Ser. No. 60/533,207, filed Dec. 30, 2003 and U.S. Provisional Patent Application Ser. No. 60/533,155, filed Dec. 30, 2003.

### TECHNICAL FIELD

The present invention is related to colored nonwoven materials and more particularly to products formed, at least in part, from colored nonwoven materials and methods for creating color schemes in such products.

### BACKGROUND OF THE INVENTION

Nonwoven materials or fabrics have been used for many years to produce a wide variety of products. Examples of such products include, but are not limited to, agricultural products such as sacks, crop covers, ground cover and weed barriers, building materials (insulation, house wraps and roofing materials), healthcare related products (caps, gowns, facial protection masks, drapes and shoe covers), respirator masks, apparel, biological protection suits, personal care products, wipes for polishing, cleaning and disinfecting, diapers, floor covering, packaging and automobile headliners and upholstery.

Nonwoven materials may be flat sheets or web type structures formed by bonding or entangling individual fibers and filaments using appropriate mechanical, thermal and/or chemical processes. Nonwoven materials may also be formed by perforating relatively thin layers of plastic film. Nonwoven materials may be combined with thin plastic films without apertures or perforations and/or nonwoven materials. Various techniques and procedures may be used to produce porous nonwoven materials and fluid resistant nonwoven materials. Nonwoven materials do not require weaving or knitting and do not require converting individual fibers or filaments into yarn.

Nonwoven materials may have a limited, single use life or may have a long, multiple use life. Nonwoven materials may be designed for specific features or functions such as absorbency, fluid resistance, resilience, softness, strength, flame resistance, cushioning, chemical resistance, filtration and bacteria or anti-microbial barrier and combinations thereof. However, these features and performance capabilities can generally only be determined by appropriate testing and inspection. Visual appearance of nonwoven materials is generally unable to identify specific features and performance characteristics.

Products may be created by combining appropriate nonwoven materials to meet specific applications while at the same time optimizing the useful life and cost of the resulting products. Nonwoven materials may have substantially the same strength, texture and appearance as woven materials. Nonwoven materials and nonwoven products may be used to provide a wide range of products.

A wide variety of techniques and procedures may be used to produce nonwoven materials and fabrics. Textile based technologies such as garnetting, carding, and needle punching may be used to form fibers and filaments into selectively oriented webs. Fabrics produced by these systems may sometimes be referred to as drylaid nonwovens. Textile based nonwoven materials may be manufactured with machinery designed to manipulate textile fibers in a dry state.

Paper based technologies such as drylaid and wetlaid systems designed to accommodate short synthetic fibers and filaments similar to wood pulp fibers may be used to produce nonwoven materials. Fabrics produced by these systems may sometimes be referred to as drylaid and wetlaid nonwovens. Paper based nonwoven materials may be manufactured with machinery designed to manipulate short fibers suspended in fluid. Such paper based nonwovens may sometimes be referred to as tissues.

Extrusion based technologies such as spunbond, meltblown, and porous and nonporous film systems may also be used to produce nonwoven materials. Fabrics produced by these systems may sometimes be referred to as spunbonded, meltblown, and textured or apertured and non-apertured film nonwovens. The term “polymer laid nonwovens” may be used to describe all extrusion based nonwovens. Extrusion based nonwovens may be manufactured with machinery associated with polymer extrusion. Fiber structures may be simultaneously formed and manipulated by many polymer laid systems.

Hybrid technologies such as hydroentangling which combine one or more techniques associated with textile based technologies, paper based technologies and extrusion based technologies may also be used to produce nonwoven materials. Nonwoven materials may be formed with a single layer or single web type structure. Nonwoven materials may also be formed with two or more sublayers or web type structures.

Various printing techniques and dyeing techniques have previously been used to produce colored nonwoven materials. Conventional color printing and dyeing techniques associated with nonwoven materials and fabrics generally do not create an appearance of depth or thickness.

Some manufacturers of nonwoven materials have used various shades of blue and green coloring to indicate basis weight of associated products. Manufacturers of colored nonwoven materials often take extra steps to produce webs of nonwoven material as uniform in color as possible. Frequently, pigments are carefully added to each web or layer of nonwoven material to produce a balanced, uniform color. Wrapping materials and shipping materials associated with products formed from nonwoven materials have previously been color coded to indicate performance characteristics such as sterilization, storage and handling process for products which will be used in a sterile or surgical-type environment.

One fabric currently on the market is a spunbond meltblown spunbond (hereinafter referred to as “SMS”) polypropylene three layer composite having a blue meltblown layer sandwiched between blue and white spunbond layers. The colors of the two blue layers appear to be the same color. It is believed that products constructed from this material have the blue layer on the outside of the products and the white layer on the inside. The white inner layer is not visible through the blue outer layer, although the blue middle layer is somewhat visible through the white inner layer. There are also instances where SMS has been made where each of the three layers are substantially the same color but slightly different shades thereof because of manufacturing imperfections and/or differences in associated manufacturing processes.

Layers of nonwoven materials with different colors, particularly two layers of nonwoven material, have often designed such that the color of one layer is not normally visible relative to the color of another layer. Significant manufacturing and quality control procedures have been used to prevent the color of one nonwoven layer from being visible through a nonwoven layer with a different color. Density, basis weight, thickness and/or loft of each nonwoven layer are often selected to occlude or prevent cooperation between the color of one layer and the color of an adjacent layer. Fiber diameter may be another factor that determines translucent or opaque characteristics of a nonwoven layer or sublayer.

Two or more layers or two sublayers of nonwoven material have often been formed with substantially the same color to avoid highlighting or showing void spaces or “thin spaces” associated with many types of nonwoven materials. Forming two or more layers or sublayers of nonwoven material with substantially the same color has often been used to provide the general appearance of uniformity and durability associated with more conventional woven materials. The same color of one layer or sublayer has been used to cooperate with the same color of an adjacent layer or sublayer to provide the desired appearance of uniformity. Again, significant manufacturing and quality control procedures have been used to prevent differences or variations between the color of one or more nonwoven layers or sublayers which are visible through one or more adjacent nonwoven layers or sublayers with substantially the same color.

One class of products of interest is medical and facial protection products. Medical and dental facial protection products are frequently used on a routine basis for many medical, dental and healthcare related activities. Surgical face masks are representative of such products. The dramatic increase of infectious diseases, such as SARS, AIDS, Avian Flu and tuberculosis has resulted in substantially increased use of face masks by both healthcare professionals (doctors, nurses, dentists) and other people working in a healthcare environment. Also, face masks are frequently worn by members of the general public as a result of concern about SARS, Avian Flu, multiple drug resistant tuberculosis (MDR-TB) and other infectious diseases.

Medical and dental facial protection products are often formed from nonwoven materials designed to provide specific features and performance capabilities such as fluid resistance, softness, filtration and bacteria or anti-microbial barriers. However, these features and performance capabilities can generally only be determined by appropriate testing and inspection. Visual appearance of a nonwoven material is generally unable to identify specific features and performance characteristics. Manufacturers of nonwoven materials for medical and dental facial protection products also often take extra steps to produce webs of nonwoven material as uniform in color as possible.

Various types of nonwoven materials have frequently been combined with each other to meet the increasing need for facial protection in the medical, dental and healthcare related activities. Also, various printing techniques and dyeing techniques have previously been used to produce colored nonwoven materials used to form medical and dental facial protection products. Some face masks have previously been produced with one color or color pattern visible on one surface or side of the face mask and a different color or color pattern visible on an opposite surface or side of the face mask.

Various types of nonwoven products have been formed with a white inner layer of nonwoven material to indicate an interior surface or inner lining. For example, some face masks have been formed with a white interior surface to indicate where the face masks are to contract a wearer's face and a generally orange outer layer to indicate fluid resistant characteristics of the face mask. However, the white inner layer and the generally orange outer layer did not cooperate with each other to produce a color scheme. In addition, a filtration layer is situated between the white inner layer and the orange outer layer. Also, coats, jackets and other garments have been formed with a white layer of nonwoven material to form an interior surface or inner lining for the associated garment. The outer layer or layers of such garments are often formed from nonwoven material having various colors such as yellow or blue. However, inner white layer and the outer colored layer or layers did not generally cooperate with each other to produce a color scheme. Frequently, pigments are carefully added to each outer web or layer of nonwoven material to produce a balanced, uniform color.

### SUMMARY OF THE INVENTION

In accordance with teachings of the present invention, nonwoven products may be formed with one or more layers of nonwoven material having a selected color scheme. The nonwoven material may be formed from fibers, films or filaments, including combinations thereof. The color scheme may be formed by differentially pigmenting fibers or filaments in one or more of the layers of nonwoven material. The color scheme may also be formed by differentially pigmenting a plastic film. Differences in color or color schemes may be used to provide a visual appearance of depth or thickness for an associated nonwoven product. Color schemes and color patterns formed in accordance with teachings of the present invention may provide a visual indication of desired functions, features or performance characteristics of an associated product. For example, medical clothing or garments appropriate for use in potentially contaminated environments may have a unique color scheme to indicate that gowns, booties, shoe covers, masks, gloves, head covers and/or coveralls meet applicable anti-microbial or fluid resistant requirements for the specific environment. In a similar manner color schemes may be established to indicate that coveralls, shoe covers, masks, gloves and other apparel meet the specific requirements for use in clean rooms. Color schemes may be selected to indicate products which meet various barrier requirements with respect to particulate matter, fluids, chemical hazards, bacteria and/or viruses. Color schemes and variations in color schemes may be used to indicate the size of a nonwoven product.

One aspect of the present invention includes differentially pigmenting the fibers or filaments in each layer or sublayer of nonwoven material such that the same type of nonwoven material may be used for each layer or sublayer of the resulting product and still provide a desired color pattern or scheme. Fibers, filaments and/or films may be differentially pigmented by varying any of a number of factors, including pigment color and concentration. The overall color or color scheme of a layer may also be varied by changing fiber or filament diameter, filament or fiber density, coverage or spacing. More than one characteristic may be varied between layers or sublayers. Additionally, some embodiments may have multiple colors or shades of color within the same layer or sublayer.

Embodiments of the present invention may allow reduction of the total amount of pigments which must be added to fibers or filaments used to form nonwoven materials while providing desired color schemes. In selected embodiments, the amount of pigments which must be added to nonwoven fibers as a percentage of the fiber denier per basis weight may be reduced. Often, less than five percent (5%) by weight of pigments will be added to a layer or sublayer of nonwoven material. The concentration of pigments may vary with respect to fibers or filaments of each layer.

For some applications, nonwoven products may be formed with multiple layers of colored nonwoven materials which cooperate with each other to produce a color scheme which provides visual identification of various functions, features, characteristics, size or performance capabilities of associated nonwoven products. Examples include, but are not limited to, each type of use associated with wipes formed from nonwoven materials indicated by respective color schemes. Each level of protection provided by chemical or biohazard suits may be indicated by respective color schemes formed in associated nonwoven materials in accordance with teachings of the present invention. Alternatively, nonwoven products may be formed with sublayers or webs which have different concentrations of pigments to produce color schemes which cooperate with each other to produce a color scheme indicating associated functions, features, characteristics or performance capabilities of the associated nonwoven product. The sublayers or webs may be formed with the same technology (spunbonded, meltblown, wet laid, dry laid, hydroentangled or extruded) or may be formed from different technologies, one sublayer spunbonded, one sublayer meltblown. Within each layer or sublayer, the concentration of pigments may vary substantially.

One aspect of the present invention includes forming nonwoven products with a layer of meltblown material disposed between a first layer of spunbonded material and a second layer of spunbonded material. Another aspect of the present invention includes forming nonwoven material from bicomponent fibers or filaments having a core disposed within a hollow sheath or tubing. For many bicomponent materials approximately sixty to ninety percent of the basis weight may be provided by the core and approximately ten to forty percent of the basis weight may be provided by the sheath. The present invention includes adding color pigments primarily to the sheath and not to the core which reduces total quantity of pigments required to produce a desired color or color scheme in nonwoven materials formed from bicomponent fibers or filaments.

Technical benefits of the present invention include eliminating or substantially reducing potential damage to meltblown nonwoven materials by substantially reducing the amount or quantity of pigments which must be added to the meltblown fibers or filaments. Another technical benefit of the present invention includes providing nonwoven products with specific color schemes which provide a visual indication of functions, features, characteristics or performance capabilities without requiring inspection and testing of the nonwoven product.

A further aspect of the present invention includes varying the color concentration of pigments added to fibers or filaments used to form a layer or sublayer of nonwoven material. Products with various color schemes may then be fabricated by using multiple layers of nonwoven material with each layer having a different color scheme or color pattern. Color or color scheme may also be varied by varying the diameter of fibers or filaments, the density of fibers or filaments, coverage and spacing, inter alia.

Technical benefits of the present invention include forming color coded garments and accessories which may be worn or used by personnel working in a specific environment, such as a medical or clean room environment. For example, colored nonwoven materials may be used to develop a first color coding system for products appropriate for use in surgical suites and a second color coding system for products appropriate for use in highly infectious isolation areas, such as Avian Flu, tuberculosis and SARS wards. Materials of the present invention may also be used to form medical products such as bandages and wraps. In another example, colored nonwoven materials may be used to code bandages having different therapeutic compositions, such as antiseptics or antibiotics. Variations in color schemes for a nonwoven product such as personnel protection equipment (PPE) and/or biohazards suits may be used to indicate sizes. Such PPE and/or biohazard suits may be more quickly donned during an emergency condition.

Nonwoven materials incorporating teachings of the present invention may be satisfactorily used to form products such as respirators for medical and other uses, including industrial uses disposable diapers, personal care products such as sanitary napkins and tampons, sterilization wraps, masks, gowns, caps and drapes associated with the healthcare industry, other disposable garments, household and personal wipes, apparel interlining, carpeting and upholstery fabrics, padding and backing, wall coverings, agricultural coverings and seed strips, automotive headliners and upholstery, filters, envelopes, tags, labels, packaging, insulation, house wrap and roofing materials, geotextiles, car or equipment covers, shade covers, other outdoor materials, bright colored safety garments, bandages and wraps, and other medical devices.

In accordance with one form of the present invention, medical and dental facial protection products may be formed with at least two layers or sublayers of nonwoven material and at least one of the layers or sublayers of nonwoven material having a different color or color scheme. Alternatively, a layer of nonwoven material with a color scheme incorporating teachings of the present invention may be combined with one or more layers of woven material to form a facial protection product. The color scheme may be formed by differentially pigmenting fibers or filaments in one or more layers of nonwoven material. A single layer or sublayer of nonwoven material may have different colors.

Differences in color, including differences in shading and/or tint of the same color, and specific color schemes may be used to provide a visual indication of desired functions, features, characteristics or performance capabilities of an associated medical or dental facial protection product. For example, color schemes and color patterns formed in accordance with teachings of the present invention may be used to indicate anti-microbial characteristics or fluid resistant characteristics of associated medical or dental facial protection products.

Anti-microbial and fluid resistance requirements may change substantially depending upon the specific environment in which facial protection products will be used. The present invention allows developing a color pattern or color scheme to indicate facial protection products which satisfy specific requirements for many different environments and levels of risk associated with medical, dental and healthcare related activities. Color patterns and color schemes formed in accordance with teachings of the present invention may indicate that facial protection products meet specific barrier requirements with respect to particulate matter from fluids, bacteria and/or viruses.

One aspect of the present invention includes forming medical and dental facial protection products from multiple layers or sublayers of nonwoven material. For example, a face mask may be formed in accordance with teachings of the present invention with a layer of meltblown material disposed between a first layer of spunbonded material and a second layer of spunbonded material. Alternatively, a layer of nonwoven material may be formed with two or more sublayers, each having a different color or color scheme. A color scheme or color pattern formed on a face mask in accordance with teachings of the present invention may be a one layer or sublayer of nonwoven material having a color scheme corresponding with robin's egg blue. Another layer or sublayer of nonwoven material may have a color scheme based on wisteria violet. A third layer or sublayer of nonwoven material may have a color scheme based on seafoam green.

A further aspect of the present invention may include forming one or more layers of nonwoven material with colors selected to substantially reduce or eliminate glare associated with typical face masks and visors. One or more layers of such nonwoven material may be placed on a face mask adjacent to the wearers eyes to minimize or prevent glare.

In accordance with one form of this invention, there is provided a nonwoven product including a first layer and a second layer. The first layer may be disposed adjacent to the second layer. The second layer forms an outer visible surface of the product. At least a portion of the first layer has a first color scheme. At least a portion of the second layer has a second color scheme. The first color scheme is different from the second color scheme. The second layer is constructed so that at least a portion of the first color scheme is visible under normal lighting conditions when viewed through at least a portion of the second layer. The first color scheme cooperates with the second color scheme to produce a third color scheme which is different from the first and second color schemes.

In accordance with another form of this invention, there is provided a nonwoven product including at least first and second layers or sublayers made from nonwoven material. The first and second layers or sublayers are differentially pigmented wherein the first layer is a first color and the second layer or sublayer is a second color. The second layer or sublayer may form an outer layer of the product. The first and second layers or sublayers cooperate with one another to create a visual image of a combination of the first and second colors on the second layer or sublayer. For some applications the basis weight (grams per square meter) of the outer layer or sublayer may be less than the basis weight of adjacent layers or sublayers to allow cooperation between the respective colors. The basis weight of each layer or sublayer may be varied from the outer layer or sublayer having the lightest or smallest basis weight and each adjacent layer or sublayer having a heavier or larger basis weight to produce a desired color scheme.

In accordance with another form of this invention, there is provided a nonwoven product including an inner layer and an adjacent outer layer. The inner layer is a first color and the outer layer is a second color. The first color is different from the second color. At least a portion of the outer layer is translucent. The translucence or opacity of the outer layer is such that the color of the inner layer is visible through at least a portion of the outer layer under normal working conditions to produce a desired color scheme when viewed from the outer layer.

In accordance with another form of this invention, there is provided a nonwoven product including an inner layer and an adjacent outer layer. The inner layer is of a different color from the color of the outer layer. The outer layer is constructed so that the color of the inner layer is visibly discernable through at least a portion of the outer layer. The first color and the second color cooperate with each other to produce a color scheme when viewed from the outer layer.

In accordance with another form of this invention, there is provided a method for forming a nonwoven product. A first color is applied to a first material. The first material is deposited on a substrate, thereby forming a first layer. A second color is applied to a second material. The second material is deposited on the first layer, thereby forming a second layer. The first and second layers form a fabric. Constructing the product so that the second layer is the outer layer. The translucence of the second layer being such that the first color is visible through at least portions of the second layer.

In accordance with another form of this invention, there is provided a method for forming a nonwoven product. A first material is deposited on a substrate, thereby forming a first layer. At least a first color is applied to the first material. A second material is deposited on the first layer, thereby forming a second layer. A second color is applied to the second material. The first and second layers form a fabric. Constructing the product so that the second layer is the outer layer. The translucence of the second layer is such that the first color is visible through at least portions of the second layer.

In accordance with another form of this invention, there is provided a nonwoven product including a first layer made of nonwoven material and a second layer made of nonwoven material. The first layer and the second layer are adjacent to one another. The first layer is a first color and the second layer is a second color. At least portions of the second layer are translucent so that the first color is visible through the second layer.

In accordance with another form of this invention, there is provided a nonwoven product including at least first, second and third layers, each made of nonwoven material. The second layer is sandwiched between the first and third layers. The first layer is a first color, the second layer is a second color and the third layer is a third color. The first, second and third colors are different colors. At least a portion of the first layer is translucent and at least a portion of the second layer is translucent so that the second and third colors are visible through the first layer. For some applications, colors associated with four or more layers of nonwoven material may be visible through the first layer.

In accordance with another form of this invention, there is provided a nonwoven product including first, second and third layers made of nonwoven materials. The second layer is sandwiched between the first and third layers. The first layer is a first color, the second layer is a second color and the third layer is a third color. The first and third colors are substantially the same. The second color is different from the first and third colors. At least a portion of the first layer is translucent and at least a portion of the third layer is translucent so that the second color is visible through the first layer and through the third layer.

One aspect of the present invention may be forming facial protection masks, medical and dental face masks, medical respirators and industrial respirators from nonwoven materials and nonwoven composites with color schemes in accordance with teachings of the present invention.

Another aspect of the present invention may be forming medical and dental products including, but not limited to, caps, gowns, head covers, shoe covers, surgical drapes, sterilization wraps, ice packs, bandages, wound dressings, medical uniforms and protective garments worn in surgery (scrubs) with color schemes in accordance with teachings of the present invention.

Another aspect of the present invention may be forming non-medical and non-dental products and non-respirator products including, but are not limited to, agricultural products, industrial products, home building products, outdoor products, personal protection equipment (PPE) and personal care products with nonwoven materials having color schemes in accordance with teachings of the present invention. Examples of such agricultural products may include, but are not limited to, crop covers, sacks, ground covers, weed barriers and seed strips. Examples of such industrial products may include, but are not limited to, equipment covers, filters, uniforms, wrapping materials, utility straps, vehicle covers, labels, tags, packaging, envelops, vehicle headliners, wipes for polishing, cleaning and/or disinfecting and padding. Examples of such home building products may include, but are not limited to, insulation, house wraps, roofing materials, wall coverings and floor pads. Examples of personal protection equipment may include uniforms, hoods, head covers, gowns, shoe covers, vests, chemical suits, biological protection suits, firefighting suits, survival suits and biohazard suits. Examples of outdoor products may include, but are not limited to, shade coverings, awnings, camouflage materials, rain gear lawn and patio furniture, tents, disposable towels, blankets and apparel. Examples of personal care products may include, but are not limited to, disposable diapers, undergarments, sanitary napkins, tampons, feminine hygiene products, and body wipes. Examples of other non-medical and non-dental products and non-respirator products may include, but are not limited to, apparel, upholstery, backing materials, interlinings and veterinary care products such as bedding, animal covers, pet garments, stall liners, animal wraps and stabilizers.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a schematic drawing in elevation showing a medical, dental or industrial respirator incorporating teachings of the present invention;

FIG. 2 is a schematic drawing in elevation showing a side view of the respirator of FIG. 1;

FIG. 3 is a schematic drawing in section taken along lines 3-3 of FIG. 2;

FIG. 4 is a schematic drawing in elevation with portions broken away showing a shoe cover formed from nonwoven materials incorporating teachings of the present invention;

FIG. 5 is a schematic drawing in elevation showing a hair cover formed from nonwoven materials incorporating teachings of the present invention;

FIG. 6 is a schematic drawing showing a surgical coat formed from nonwoven materials incorporating teachings of the present invention;

FIG. 7 is a schematic drawing with portions broken away showing one example of multiple layers of nonwoven material having different color schemes in accordance with teachings of the present invention;

FIG. 8 is a schematic drawing with portions broken away showing a bicomponent fiber formed in accordance with teachings of the present invention;

FIG. 9 is a schematic drawing in elevation showing a face mask formed in part from nonwoven materials incorporating the teachings of the present invention;

FIG. 10 is a schematic drawing in elevation showing another example of a face mask formed in part from nonwoven materials incorporating the teachings of the present invention;

FIG. 11 is a schematic drawing in elevation showing a visor and face mask formed in part from nonwoven materials incorporating the teachings of the present invention;

FIG. 12 is a pictorial view of a two layer fabric formed in accordance with the teachings of the present invention;

FIG. 13 is an elevational view of the fabric of FIG. 12;

FIG. 14 is a sectional view of the fabric of FIG. 13 taken through section lines 14-14 illustrating the visual discernability of the colors from the fabric;

FIG. 15 is a pictorial view of a three layer fabric formed in accordance with the teachings of the present invention;

FIG. 16 is a sectional view of the fabric of FIG. 15 and illustrating the color transmission of the fabric;

FIG. 17 is an isometric view of a trilobal filament with different colors on each lobe in accordance with the teachings of the present invention;

FIG. 18 is a schematic drawing showing a hospital gown formed from nonwoven materials incorporating the teachings of the present invention;

FIG. 19 is a schematic drawing showing a biological hazard suit formed from nonwoven materials incorporating the teachings of the present invention;

FIG. 20 is a schematic drawing showing a diaper worn by an infant formed from nonwoven materials incorporating the teachings of the present invention;

FIG. 21 is schematic drawing showing a surgical drape formed from nonwoven materials incorporating the teachings of the present invention;

FIG. 22 is a schematic drawing showing a feminine hygiene product formed from nonwoven materials incorporating the teachings of the present invention;

FIG. 23 is a schematic drawing showing a wipe formed from nonwoven materials incorporating the teachings of the present invention;

FIG. 24 is a schematic drawing showing a healthcare worker wearing a head cover, a surgical mask, a gown and shoe covers all of which are made from nonwoven materials incorporating the teachings of the present invention;

FIG. 25 is a block diagram showing a method for producing a nonwoven fabric incorporating teachings of the present invention; and

FIG. 26 is a pictorial view of an apparatus, in a simplified form, which may be used for carrying out a method incorporating teachings of the present invention.

### DETAILED DESCRIPTION OF THE INVENTION

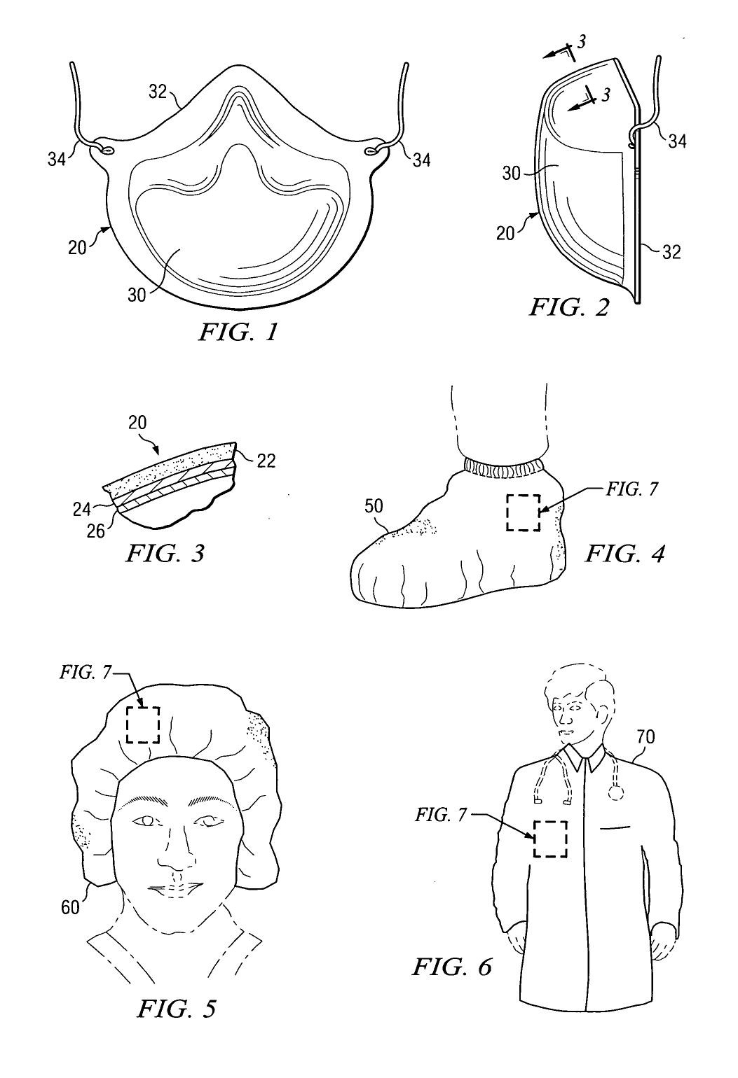

Preferred embodiments of the invention and its advantages are best understood by reference to FIGS. 1-26 wherein like numbers refer to same and like parts.

The terms “nonwoven product” and “nonwoven products” as used in this application include, but are not limited to, respirators including medical respirators and industrial respirators, disposable diapers, sanitary napkins and tampons, sterilization wraps, medical and dental facial protection products including face masks and any products formed at least in part from nonwoven materials for use in any medical, healthcare or dental applications, gowns, caps and drapes associated with the healthcare industry, other disposable garments, household and personal wipes, apparel interlining, floor covering and upholstery fabrics, padding and backing, wall coverings, agricultural coverings and seed strips, automotive headliners and upholstery, filters, envelopes, tags, labels, insulation, house wraps, roofing materials, geotextiles, car or equipment covers, shade covers, other outdoor materials, bandages and wraps, and other medical devices formed at least in part from nonwoven materials, and nonwoven composites. The term “nonwoven composites” may be used to describe nonwoven materials combined with thin plastic films with or without perforations or apertures and/or woven materials.

The term “pigment” as used in this application shall mean any finely powdered natural or synthetic color material which may be satisfactorily used to add color to fibers, filaments and plastic films used to form nonwoven materials. Pigments are often mixed with oil, water or other suitable liquids to form paint, ink or dye. One aspect of the present invention includes varying the concentration of pigments directly added to fibers, filaments and plastic films during the process of forming respective layers or sublayers of nonwoven materials and/or fabrics.

The term “spunbonded”, as used in this application, includes nonwoven materials and fabrics formed by extrusion of polymer based filaments or fibers which may then be laid down in the form of a web and subsequently bonded.

The term “meltblown”, as used in this application, includes nonwoven materials and fabrics formed by melt extruding a polymer through a die into a high velocity stream of hot air which converts the polymer into fine, relatively short fibers or filaments. The fibers or filaments may be collected on a sheet on a moving screen and later bonded with each other or other materials.

The term “nonwoven materials” as used in this application also includes nonwoven fabrics. Nonwoven materials and fabrics may be flat sheets or web type structures formed by bonding or entangling separate fibers or filaments using appropriate mechanical, thermal and/or chemical processes. Nonwoven materials and fabrics may also be formed, at least in part by, plastic films.

Various techniques and procedures may be used to produce porous nonwoven materials and fluid resistant nonwoven materials. Some nonwoven materials are sometimes referred to as “spunbonded” or “meltblown” as an indication of the associated techniques and procedures used to form the respective nonwoven material. Other nonwoven materials may sometimes be formed by extruding relatively thin plastic films. Some plastic films may be perforated. Other plastic films may have no holes or apertures. Nonwoven materials do not require weaving or knitting and do not require converting individual fibers or filaments into yarn. Other processes may be used to produce nonwoven materials. For example, nonwoven materials and fabrics may be wet laid, dry laid or hydroentangled.

Accordingly, the term “fibers or filaments” may include mixtures of primarily fibers, primarily filaments or combinations thereof as formed or used in the selected technique for producing nonwoven materials.

The term “color scheme” is used in this application to include any combination or arrangement of colors, shades of colors within one or more layers or sublayers of nonwoven material or a nonwoven composite to produce a desired visual appearance. For example, some color schemes formed in accordance with teachings of the present invention may produce a relatively uniform pattern of different colors or changes in shading or tint of the same color within a layer or sublayer of nonwoven material or a nonwoven composite. Some color schemes may create a generally random appearance with respect to changes in different colors or changes in shading or tint of the same color within a layer or sublayer of nonwoven material or a nonwoven composite. Such apparently random changes in color shading or tint may be desirable to produce an appearance of thickness or depth. A matrix of different colors or a matrix of different tints or shadings of the same color may be used to produce a desired color scheme in multiple layers or sublayers of nonwoven material or a nonwoven composite. Also, a color scheme incorporating teachings of the present invention may include one layer or sublayer having a generally uniform color in combination with other layers or sublayers having variations in color to provide a desired visual indication of performance characteristics of the resulting nonwoven product. Substantial variations in shading or tint may also be used in one or more layers or sublayers.

FIGS. 1 through 24 show various examples of nonwoven products, nonwoven materials and fibers or filaments formed in accordance with teachings of the present invention. Respirator 20, as shown in FIGS. 1, 2 and 3, may generally be described as a medical respirator, a dental respirator or as an industrial respirator depending in part upon performance characteristics of nonwoven materials used to form respirator 20. Multiple layers of material 22, 24 and 26 may be molded with each other to produce relatively rigid central portion 30 and relatively thin, flat peripheral portion 32. For some applications, central portion 30 may have a generally “cup-shaped” configuration to accommodate the face of a wearer and provide an air exchange chamber. Peripheral portion 32 may be relatively thin and flat to form a seal with the face of a wearer. Various types of ties, bands and/or strings 34 may be attached with peripheral area 32 for use in securing respirator 32 with the face of a wearer (not expressly shown). A color scheme formed in accordance with teachings of the present invention is preferably visible from the exterior of respirator 20 to provide a visual indication of associated features and performance characteristics appropriate for use in various medical, dental and industrial environments.

Layers 22, 24 and 26, as shown in FIG. 3, may be formed from various types of nonwoven materials which cooperate with each other to form a color scheme incorporating teachings of the present invention. For some applications, only layer 22 may be formed from nonwoven material having a color scheme incorporating teachings of the present invention. Alternatively, one or more layers 22, 24 or 26 may be formed from sublayers or webs of nonwoven material which cooperate with each other to form a color scheme. For example, layer 22 may be formed from two or more sublayers which produce a desired color scheme.

Extrusion based technologies such as spunbonded, meltblown, porous and nonporous film systems may be used to produce nonwoven materials.

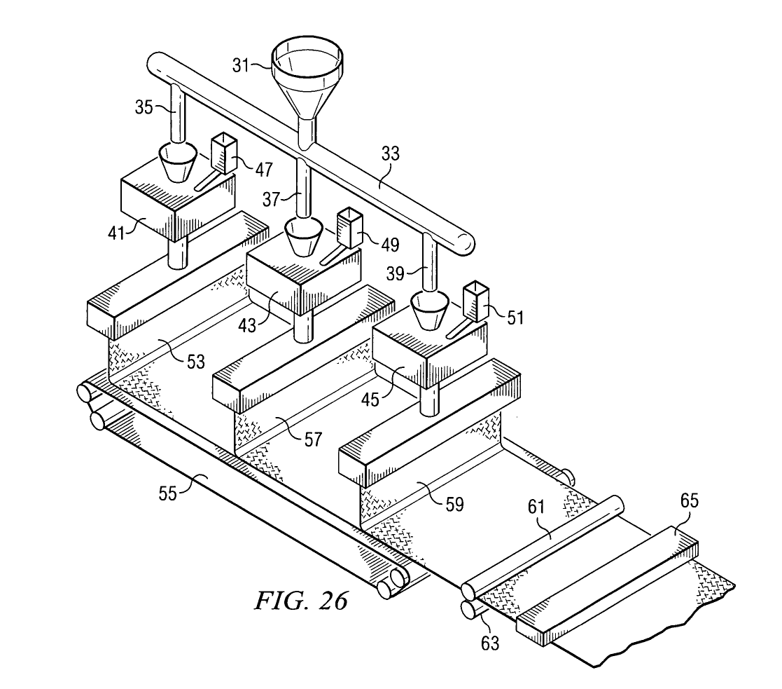

In reference to FIGS. 25 and 26, products and fabric constructed from multi-colored layers incorporating the teachings of the present invention may be made using method and apparatus discussed below.

Referring now more particularly to FIG. 25, which is a block diagram illustrating a method for producing two layer fabric. Blocks 11 and 13 demonstrate that the method starts with a resin, such as polypropylene. A first pigment is added to one of the resins, as illustrated by block 15, and a second pigment is added to the other resin as illustrated by block 17. The first and second pigments may be different colors or different shades of the same color. The resin colored with the first pigment is then extruded as illustrated by block 17 into multiple filaments as illustrated by block 19. As illustrated by block 21, the resin containing the second pigment is also extruded into a plurality of filaments. The extruded filaments from block 19 form a first web as illustrated by block 23 and the extruded filaments from block 21 form a second web as illustrated by block 25. As illustrated by block 27, the webs are combined, thereby forming first and second differentiated layers. As illustrated by block 29, the two layered fabric may then be used to assemble a nonwoven product, such as the products referred to above.

FIG. 26 illustrates an apparatus for producing three layers having two layers such as of spunbond polypropylene with a layer of meltblown polypropylene sandwiched therebetween, also known as SMS. Hopper 31 is provided for receiving pigmented polypropylene chips. Hopper 31 is connected to manifold 33 having outlets 35, 37 and 39 disbursing the polypropylene chips into extruders 41, 43 and 45. Extruders 41 and 45 may be spunbond extruders and extruder 43 may be a meltblown extruder. Pigment containers 47, 49 and 51 may be connected to extruders 41, 43 and 45 for adding differentially colored pigment to the extruders. For some embodiments the colors in containers 47 and 51 may be the same or substantially the same. First web 53 of spunbond polypropylene may be laid onto a moving substrate or belt 55 forming a first layer or web of nonwoven material of a first color. Extruder 43 forms a layer of meltblown polypropylene 57 which may be deposited on top of layer 53 and a layer of spunbond polypropylene 59 may be deposited on top of meltblown layer 57. Rollers 61 and 63 calendar the three layers into a multi-colored SMS fabric 65. It may be preferred that the nonwoven materials, in particularly the nonwoven material forming the outer layer of the assembled product, have sufficient opacity or translucence such that a desired color scheme may be visible when the assembled product is viewed from the outer layer. The opacity or translucence of each layer or sublayer may be determined by varying one or more of the following characteristics of the nonwoven materials: fiber or filament diameter, fiber or filament density and/or basis weight of each layer, fiber or filament shape, pigment concentration, web coverage, fiber dispersion and/or color selection.

In a specific embodiment, fibers or filaments associated with spunbonded and meltblown nonwoven materials are often formed using an extrusion head or an extrusion beam. A hopper is typically associated with each extrusion head or extrusion beam for use in adding pigments to the polymeric material during the process of forming respective fibers and filaments. For example, a first hopper and extrusion head or extrusion beam may cooperate with each other to add approximately five to six percent by basis weight of pigments to the associated fibers or filaments. A second hopper and associated extrusion head or extrusion beam may be used to add three or four percent of pigments by basis weight to the associated fibers or filaments. A third hopper and extrusion head may be used to add one or two percent by basis weight of pigments to the associated fibers or filaments. The extrusion heads may be used to form separate layers of nonwoven material or they may be used to form sublayers of nonwoven material. Alternatively, the extrusion heads may cooperate with each other to form sublayers or webs of respective spunbonded meltblown and spunbonded material. The size of the fibers used to form each layer and the concentration of pigments are selected to provide a visual indication of the performance characteristics of the product, such as a facial protection product, formed from the nonwoven material.

However, in other applications it may be possible to construct a series of valves (not expressly shown) that allow connection of multiple hoppers to a single extrusion head to produce fibers or filaments with discontinuous pigmentation. These fibers or filaments may be used to produce a single layer or sublayer having different colors or a varied color scheme. For example, concentration of a single pigment may be varied in each hopper connected to the extrusion head, thereby allowing production of a layer having the same general coloration, but with a color scheme including slightly different colors.

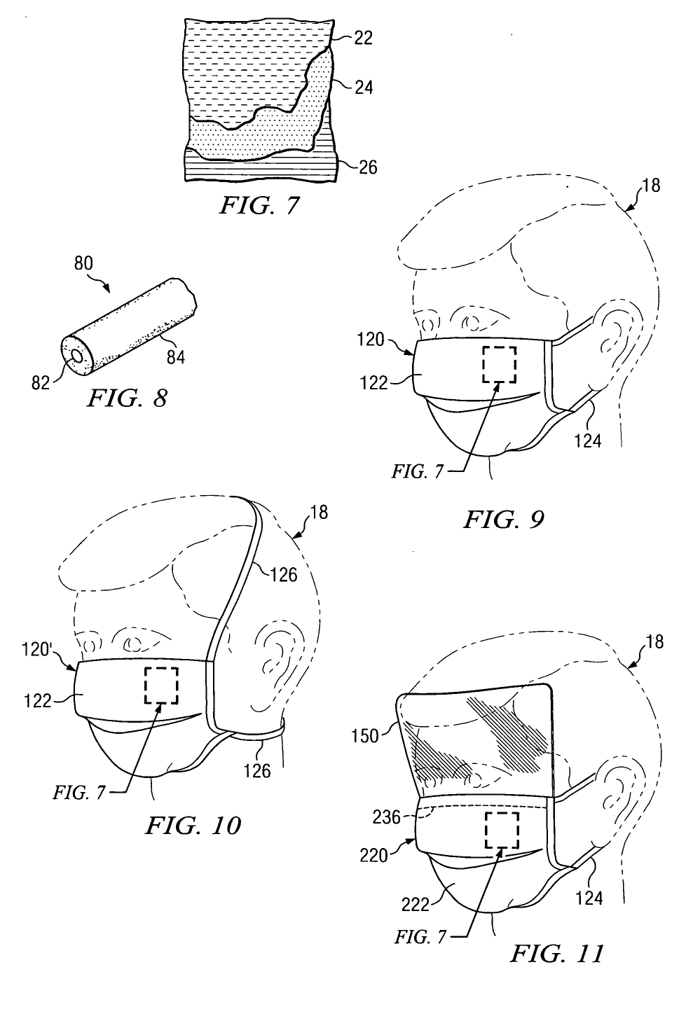

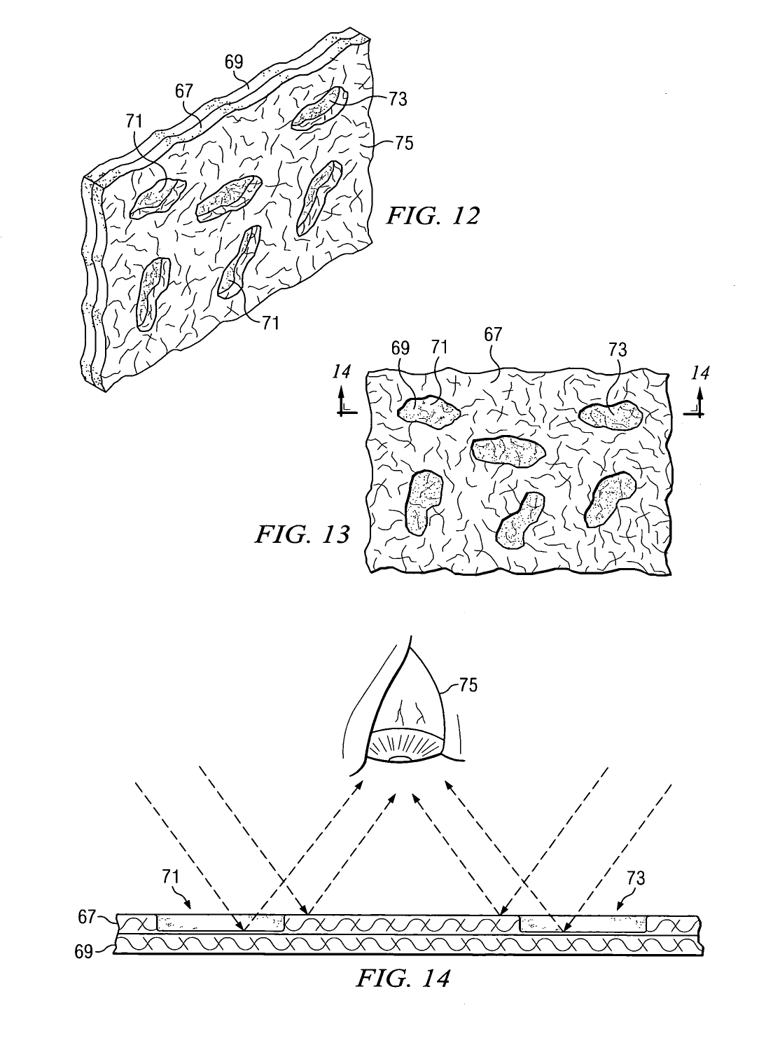

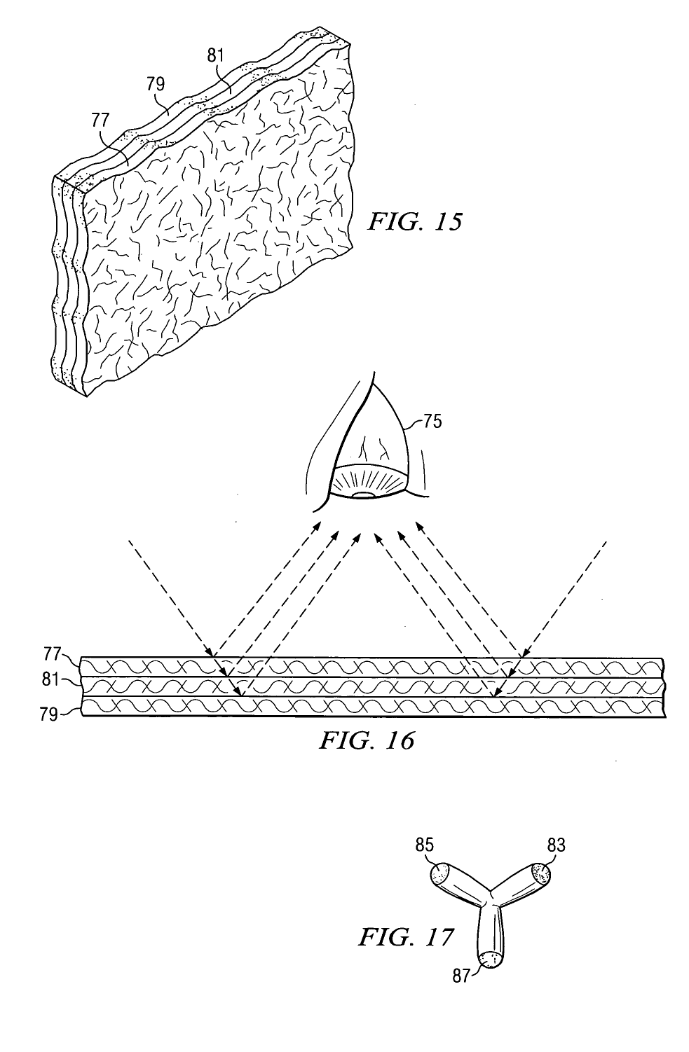

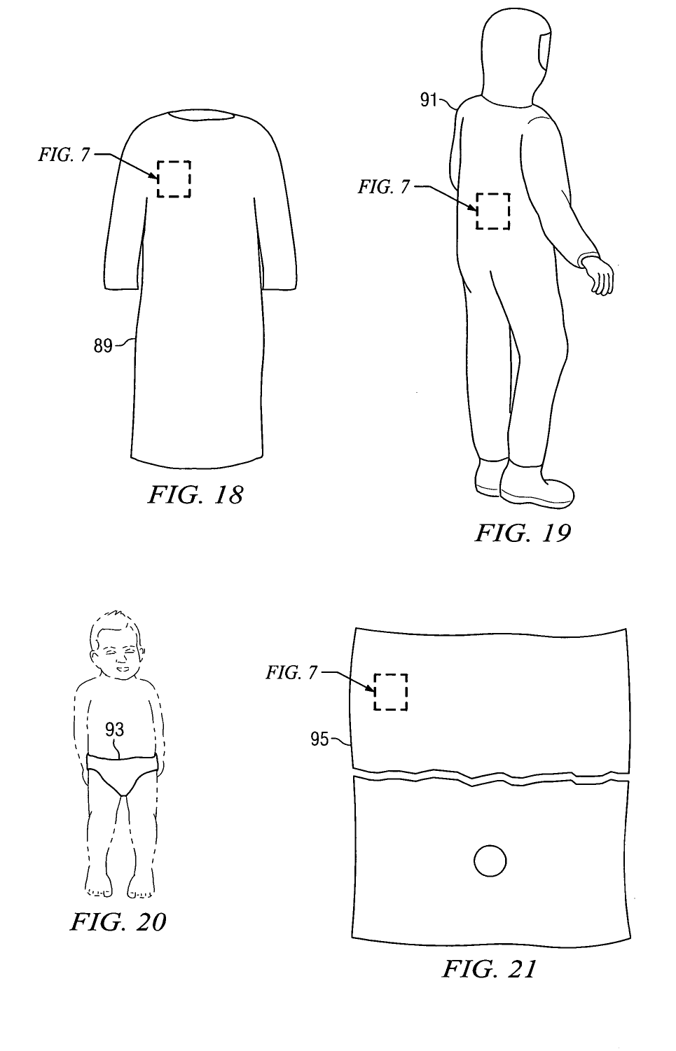

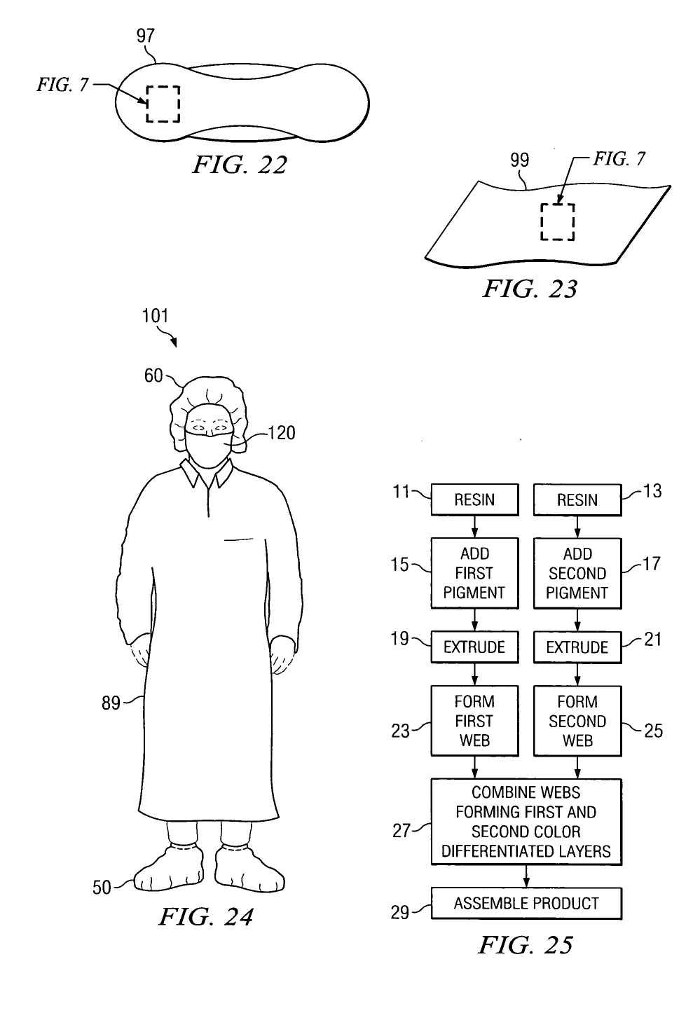

Referring now more particularly to FIG. 7, for some applications, layer 22 may be formed from spunbonded material. Layer 24 may be formed from meltblown material. Layer 26 may be formed from spunbonded material. Selected color pigments and concentrations may be added to the fibers and/or filaments associated with each layer 22, 24 and 26 to produce a desired color scheme visible from at least one side or surface of respirator 20.

For other applications, respirator 20 may be formed in part with at least one layer of nonwoven material having two or more sublayers. Each sublayer of nonwoven material may be formed from the same type of nonwoven material such as spunbonded or meltblown. Each sublayer of the nonwoven material may have a different color or color scheme. Alternatively, each sublayer may be formed from a different type of nonwoven material and also with a different color scheme formed on each sublayer. In addition to spunbonded and meltblown techniques, nonwoven materials of the present invention may be produced by any known technique for use in generating nonwoven materials. These techniques may include dry laid techniques. For example a separate card may be used for each layer. The fibers or filaments provided on each card may be substantially one color or may vary in color or concentration of pigment. Wet laid techniques may also be used. For example pigment may be added to the slurry used to form each layer or sublayer. The slurry for each layer or sublayer may have substantially the same pigment or concentration throughout, or pigment color or concentration may be varied in different areas of the slurry to produce variation in the layer formed. Nonwoven materials may also be produced using hydroentanglement techniques. For example, pigments may be added to a water jet to produce different color schemes. Other nonwoven material production techniques including, but not limited to, extruding perforated thin plastic films and nonperforated thin plastic films, may also be used.

Color or color schemes in any production technique may be varied by selectively blending or adding pigmented and non-pigmented fibers or filaments. Overall color or color scheme of the completed nonwoven material layer or sublayer may also be affected by concentration of pigments, fiber or filament density, fiber or filament diameter, coverage and spacing, inter alia. More than one of these characteristics may be varied between layers or sublayers or within a given layer or sublayer.

FIG. 4 shows one example of shoe covering 50 which may be formed from nonwoven materials having a color scheme incorporating teachings of the present invention.

FIG. 5 shows one example of head covering 60 which may be formed from nonwoven materials having a color scheme incorporating teachings of the present invention.

FIG. 6 shows one example of a jacket or coat 70 which may be formed from nonwoven materials incorporating teachings of the present invention. Layers of nonwoven material as shown in FIG. 7 may be used to form shoe covering 50, head covering 60, coat 70, and the outer cover of the masks shown in FIGS. 9-11.

FIG. 8 is a schematic drawing showing one example of a fiber or filament which may be satisfactorily used to form nonwoven materials and fabrics in accordance with teachings of the present invention. For the embodiment shown in FIG. 8, bicomponent fiber 80 preferably includes core 82 disposed within hollow sheath 84. Pigments used to form an associated color scheme are preferably added to sheath 84 with only a relatively small percent (less than ten percent) of the pigments added to core 82. Various techniques associated with forming bicomponent fibers and filaments may satisfactorily be used. Typically, one or more hoppers (not expressly shown) may be used to add desired concentration of pigments to sheets 84 during an associated extrusion process which results in only a limited number of pigments being added to core 82. Core 82, in some embodiments may contain no pigment; all pigment may be contained in the sheath 84.

FIG. 9 is a schematic drawing showing face mask 120 disposed on the face of wearer 18. Face mask 120 may be formed from a wide variety of nonwoven materials including, but not limited to, spunbonded and meltblown materials. Face mask 120 may include mask body 122 formed at least in part from nonwoven materials and ear loops 124. The dimensions and configuration of face mask body 122 may be selected to conform with the face of wearer 18. Ear loops 124 may be formed from various types of elastomeric and/or resilient nonwoven material to provide desired fit and seal with the face of wearer 18.

For the embodiment shown in FIG. 9, face mask 120 may be formed from at least three layers of nonwoven material. For example, as shown in FIGS. 3 and 7, layer 22 may be formed from spunbonded material. Layer 26 may be formed from spunbonded material. Selected color pigments have preferably been added to the fibers and/or filaments used to form each layer of nonwoven material 22, 24 and 26 to produce a desired color scheme visible from at least one side of face mask 120. For example, appropriate pigments may be added to the fibers used to form layer 22 to produce a color scheme based on robin's egg blue. Appropriate pigments may be added to the fibers used to form layer 24 to produce a color scheme corresponding with wisteria violet. In a similar manner, pigments may be added to layer 26 to produce a color scheme based on seafoam green.

### EXAMPLE

A face mask product having an outer fabric made of SMS as described below has been produced.

| Nonwoven material | % Pigment by weight | Nominal Basis Weight |
|---|---|---|
| Spunbond | 2.4% seagreen | 10 grams/square meter |
| Meltblown | 2% wisteria | 5 grams/square meter |
| Spunbond | 3% robin's egg blue | 10 grams/square meter |

For other applications, face mask 120 may be formed in part from at least one layer of nonwoven material having two or more sublayers. For example, face mask body 122 may be formed from a layer of nonwoven material (not expressly shown) having a first sublayer, second sublayer and a third sublayer. Each sublayer of nonwoven material may be formed from the same type of nonwoven material such as spunbonded or meltblown. Each sublayer of the nonwoven material may have a different color or color scheme such as previously described with respect to layers 22, 24 and 26. Teachings of the present invention may be satisfactorily used to form desired color schemes on multiple layers of different types of nonwoven material or may be used to form desired color schemes on multiple layers of the same type of nonwoven material. Also, the present invention may be used to form desired color schemes on sublayers of the same type of nonwoven material which may then be combined to form a single layer or web of nonwoven material. Finally, the present invention may be used to form desired color schemes including more than one color in the same layer or sublayer.

For some applications, face mask 120 may be formed with an outer layer, a middle filtration layer and an interfacing layer. Each layer may be formed from multiple layers of nonwoven material (not expressly shown). For example, face mask 120 may be formed with an outer layer (not expressly shown) formed from sublayers of spunbonded, meltblown, meltblown and spunbonded material. The outer most layer may also be formed from spunbonded, spunbonded meltblown and spunbonded sublayers or spunbonded, spunbonded and meltblown sublayers. The desired color 'scheme to indicate performance characteristics of the resulting face mask 120 may be provided in one or more of the sublayers. The middle layer (not expressly shown) may have various sublayers or subcomponents such as meltblown and spunbonded. One or more sublayers of meltblown material may be added to provide desired filtration characteristics and one or more spunbonded layers added to provide a carrier for the meltblown material.

In addition to spunbonded and meltblown techniques, nonwoven materials of the present invention may be produced by any known technique for use in generating nonwoven materials. These techniques may include dry laid techniques. For example, a separate card may be used for each layer. The fibers or filaments provided on each card may be substantially one color or may vary in color or concentration of pigment. Wet laid techniques may also be used. For example, pigment may be added to the slurry used to form each layer or sublayer. The slurry for each layer or sublayer may have substantially the same pigment or concentration throughout, or pigment color of concentration may be varied in different areas of the slurry to produce variation in the layer formed. Nonwoven materials may also be produced using hydroentanglement techniques. For example, pigments may be added to a water jet to produce different color schemes. Other nonwoven material production techniques may also be used.

Color or color scheme in any production technique may be varied by selectively blending or adding pigmented and non-pigmented fibers or filaments. Overall color or color scheme of the completed nonwoven material layer or sublayer may also be affected by concentration of pigments, fiber or filament density, fiber or filament diameter, coverage and spacing, inter alia. More than one of these characteristics may be varied between layers or sublayers or within a given layer or sublayer.

FIG. 10 is a schematic drawing showing face mask 120′ disposed on the face of wearer 18. Face mask 120′ may include previously described face mask body 122 along with surgical ties 126. Teachings of the present invention may also be used to provide a desired color scheme with respect to nonwoven materials used to form surgical ties 126. For example, the color scheme associated with surgical ties 126 may correspond with the color scheme of face mask body 122. Alternatively, surgical ties 126 may have a different color scheme to indicate specific functions or characteristics of the associated face mask 120′. For some applications, surgical ties 126 may have a unique or specific color scheme while face mask body 122 includes a conventional or standard color scheme.

FIG. 11 is a schematic drawing showing face mask 220 with visor 150 attached to face mask body 222. For some applications a region or strip of relatively dark coloration may be formed on face mask body 222 adjacent to visor 150. Dotted line 236 shows one example of a relatively dark region which may be formed on face mask body 222 to reduce glare.

For example, face mask body 222 may be formed with a layer or a sublayer of nonwoven material having a darkened region disposed adjacent to visor 150. Alternatively, bindings (not expressly shown) disposed on the edges of face mask body 222 may be formed from nonwoven materials having a dark or sometimes generally black coloration to reduce glare. The present invention allows adding desired pigmentation to either face mask body 222, ear loops 124 and/or bindings associated with face mask 220 to substantially reduce or eliminate any glare associated with wearing visor 150.

Color schemes and color patterns may be formed on face mask body 222 bindings and ear loops 124 and/or associated bindings to provide optimum visual performance from wearing face mask 220 based on the intended environment. For example, the present invention allows developing color schemes which may be particularly beneficial for use in laser surgery, or surgery associated with unique lighting environments to better illuminate the surgical field.

FIG. 7 is a schematic drawing showing layers of nonwoven material 22, 24 and 26 having different color schemes formed on each layer in accordance with teachings of the present invention. For some applications each layer 22, 24 and 26 may be formed from the same type of spunbonded material, meltblown material or thin plastic film material. For other applications as represented by face masks 120, 120′ and 220, layer 22 may be formed from spunbonded material. Layer 24 may be formed from meltblown material. Layer 26 may be formed from spunbonded material. Alternatively, layers 22, 24 and 26 may represent sublayers of a web or layer of nonwoven material. One or the technical benefits of the present invention includes the ability to form the same type of nonwoven material with different color schemes or to form different types of nonwoven material with different color schemes.

FIGS. 12-14 illustrate a fabric having two layers (or sublayers) 67 and 69 of differentially colored adjacent nonwoven materials. In the embodiment of FIGS. 12-14, at least layer 67, which may be the outer layer of a product made from the fabric, is made by a process in which layer 67 is formed with at least one zone, such as zones 71 and 73, which are more translucent than other portions 75 of layer 67. These more translucent zones may be formed because of the lack of uniformity in the production of the nonwoven material, in particularly in the production of spunbond polypropylene which is formed by randomly deposited entangled filaments. As best illustrated in FIG. 13, because of the translucence of zones 71 and 73, the color from layer 69 may be more visible through zones 71 and 73 in layer 67. As stated previously, layer 67 may be the outer layer of the nonwoven product constructed from this fabric. Thus, as is best illustrated in FIG. 14, the human eye 75 will see light reflected from layer 69 through zones 71 and 73, as well as light reflected from the top portion of layer 67. Since layers 67 and 69 are of different colors, the viewer will perceive a multi-colored fabric. In addition, while FIG. 14 only shows more translucent areas in one layer of the two layer fabric, it is preferred that both layers include zones that are more translucent so that two colors can be observed from either side of the fabric.

FIGS. 15 and 16 illustrate fabric made of three layers, namely, an outer layer 77, an inner layer 79, with a middle layer 81 sandwiched therebetween. The fabric illustrated in FIG. 15 may be made by the SMS process shown in FIG. 26. Each layer 77, 79 and 81 may be made of different colors or different shades of the same color. For one embodiment, the outer layer 77 and the inner layer 79 may be made of substantially the same color with the middle layer 81 being made of a different color. In the embodiment of FIGS. 15 and 16, each layer is made from a more uniform process so that there are few, if any, very thin areas, although at least outer layer 77 and middle layer 81 must be somewhat translucent so that, as illustrated in FIG. 16, the color from the inner layer 79 must pass through middle layer 81 and outer layer 77 and the colors from middle layer 81 must pass through outer layer 77 so that the human eye will perceive the three layer fabric as a three color fabric. It is also preferred that inner layer 79 be translucent so that three colors may be observed from either side of the fabric.

Nonwoven materials with basis weight less than 2 ounces/square yard for each layer or sublayer generally allow cooperation between respective colors (different colors or different shades of the same color) of each layer or sublayer in accordance with teachings of the present invention.

Nonwoven materials with typically between 1% and 5% color pigment by basis weight (grams/square meter) generally allow cooperation between respective colors (different colors or different shades of the same color) of each layer or sublayer in accordance with teachings of the present invention.

Nonwoven materials with large diameter fibers or filaments are generally more translucent and allow cooperation between respective colors (different colors or different shades of the same color) of each layer or sublayer in accordance with teachings of the present invention.

Nonwoven materials with basis weights of 2 or 3 ounces or more per square meter are generally opaque and do not allow cooperation between respective colors (different colors or different shades of the same color) of each layer or sublayer.

FIG. 17 illustrates a trilobal filament having differential colors or different shades of the same color at the tips of lobes 83, 85 and 87. The use of trilobal filaments may be useful in carrying out the teachings of the invention.

FIG. 18 shows one example of a gown 89 which may be formed from nonwoven materials having a color scheme incorporating the teachings of the present invention.

FIG. 19 shows one example of a biological hazard suit 91 which may be formed from nonwoven materials having a color scheme incorporating the teachings of the present invention.

FIG. 20 shows an infant wearing a diaper 93 which may be formed from nonwoven materials having a color scheme incorporating the teachings of the present invention.

FIG. 21 shows a surgical drape 95 which may be formed from nonwoven materials having a color scheme incorporating the teachings of the present invention.

FIG. 22 shows a feminine hygiene product such as a sanitary napkin 97 which may be formed from nonwoven materials having a color scheme incorporating the teachings of the present invention.

FIG. 23 shows a wipe 99 which may be formed from nonwoven materials having a color scheme incorporating the teachings of the present invention.

FIG. 24 shows a healthcare worker 101 where hat 60, mask 120, gown 89, and shoe covers 50 which may be formed from nonwoven materials having a color scheme incorporating the teachings of the present invention. Preferably each item which healthcare worker 101 is wearing incorporates the same color scheme so as to show that the healthcare worker is fully protected for a specific environment. For example, the color scheme could be blue-green-purple color scheme to indicate that the healthcare worker is protected from bodily fluids while a yellow-orange-green color scheme could indicate that the healthcare worker is protected from a certain pathogen hazard.

Although the present invention and its advantages have been described in detail, it should be understood that various changes, substitutions and alternations can be made herein without departing from the spirit and scope of the invention as defined by the following claims.

1. A nonwoven product formed with at least two layers of nonwoven material comprising:
each layer of nonwoven material having a respective color scheme formed by pigmented fibers or filaments;
at least one of the layers of nonwoven material having a color scheme different from the color scheme of one other layer of nonwoven material; and
the color scheme visible from at least a portion of the product.

2. The product of claim 1 further comprising the color scheme formed by varying a nonwoven material characteristic selected from the group consisting of: pigment color, pigment concentration, fiber or filament density, fiber or filament diameter, coverage, spacing and any combinations thereof.

3. The nonwoven product of claim 1 further comprising:
at least one of the layers of nonwoven material formed from bicomponent fibers defined in part by a core disposed within a hollow sheath;
color pigments used to form the desired color scheme disposed within the sheath and the core; and
the amount of color pigment disposed within the sheath substantially larger than the amount of color pigments disposed within the core.

4. The nonwoven product of claim 3, further comprising substantially no pigment disposed in the core.

5. The nonwoven product of claim 1 further comprising the color scheme of a first layer, second layer and third layer cooperating with each other to create an appearance of depth.

6. The nonwoven product of claim 1 further comprising a medical respirator.

7. The nonwoven product of claim 1 further comprising an industrial respirator.

8. The nonwoven product of claim 1 further comprising pigments added to the nonwoven material to provide the desired color scheme for each layer.

9. The nonwoven product of claim 1 selected from the group consisting of facial protection masks, medical and dental face masks, medical respirators and industrial respirators.

10. The nonwoven product of claim 1 selected from the group consisting of medical and dental products including caps, gowns, head covers, shoe covers, surgical drapes, sterilization wraps, ice packs, bandages, wound dressings, medical uniforms, and protective garments worn in surgery.

11. The nonwoven product as set forth in claim 1 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

12. A nonwoven product formed with at least two layers of nonwoven material comprising:
each layer of nonwoven material having a respective color scheme formed by adding differentially pigmented fibers or filaments;
at least one of the layers having at least two colors formed by adding differentially pigmented fibers or filaments;
at least one of the layers of nonwoven material having a color scheme different from the color scheme of one of the other layers of nonwoven material; and
the color scheme visible from at least a portion of the product.

13. The product of claim 12 further comprising the color scheme formed by varying a nonwoven material characteristic selected from the group consisting of: pigment color, pigment concentration, fiber or filament density, fiber or filament diameter, coverage, spacing and any combinations thereof.

14. The product of claim 12, further comprising the at least two colors in at least one layer formed by varying a nonwoven material characteristic selected from the group consisting of: pigment color, pigment concentration, fiber or filament density, fiber or filament diameter, coverage, spacing and any combinations thereof.

15. The nonwoven product of claim 12 further comprising:
at least one of the layers of nonwoven material formed from bicomponent fibers defined in part by a core disposed within a hollow sheath;
color pigments used to form the desired color scheme disposed within the sheath and the core; and
the amount of color pigment disposed within the sheath substantially larger than the amount of color pigments disposed within the core.

16. The nonwoven product of claim 15, further comprising substantially no pigment disposed in the core.

17. The nonwoven product of claim 12 further comprising the color scheme of the first layer, second layer and third layer cooperating with each other to create the appearance of depth.

18. The nonwoven product of claim 12 further comprising a medical respirator.

19. The nonwoven product of claim 12 further comprising an industrial respirator.

20. The nonwoven product of claim 12 further comprising pigments added to the nonwoven material to provide the desired color scheme for each layer.

21. A medical facial protection product formed with at least two layers of nonwoven material comprising:
each layer of nonwoven material having a color scheme formed in part by pigmented fibers or filaments;
the color scheme formed on one of the layers of nonwoven material different from the color scheme formed on one of the other layers of nonwoven material; and
the color scheme visible from at least a portion of the product.

22. The medical facial protection product of claim 21 further comprising the color scheme formed by varying a nonwoven material characteristic selected from the group consisting of: pigment color, pigment concentration, fiber or filament density, fiber or filament diameter, coverage, spacing and any combinations thereof.

23. The medical facial protection product of claim 21 further comprising at least three layers of nonwoven material with each layer of nonwoven material having a different color scheme.

24. The medical facial protection product of claim 21 further comprising:
at least three layers of nonwoven material with each layer having a different color scheme;
one of the layers of nonwoven material having a color scheme corresponding with robin's egg blue;
another layer of nonwoven material having a color scheme based on wisteria violet; and
a third layer of nonwoven material having a color scheme based on seafoam green.

25. The medical facial protection product of claim 23 further comprising:
the first layer of nonwoven material having spunbonded fibers;
the second layer of nonwoven material having meltblown fibers; and
the third layer of nonwoven material having spunbonded fibers.

26. A medical facial protection product comprising:
at least one layer of nonwoven material formed with at least two sublayers of the same type of nonwoven material;
at least one of the sublayers having a color scheme formed by adding pigments to the sublayer; and
the color scheme visable from at least one side of the facial protection product.

27. The medical facial protection product of claim 26 further comprising the nonwoven layer forming an outer surface of the facial protection product.

28. The facial protection product of claim 26 further comprising:
a binding disposed along at least one edge of the face mask; and
the binding formed from a nonwoven material having a color scheme which reduces glare.

29. The medical facial protection product of claim 26 further comprising:
a face mask body with surgical ties attached thereto; and
the surgical ties formed from nonwoven materials having a color scheme which reduces glare.

30. A dental facial protection product formed with at least two layers of nonwoven material comprising:
each layer of nonwoven material having a color scheme; and
at least one of the layers of nonwoven material having a color scheme different from the color scheme of one of the other layers of nonwoven material.

31. The dental facial protection product of claim 30 further comprising at least three layers of nonwoven material with each layer of nonwoven material having a different color scheme.

32. The dental facial protection product of claim 30 further comprising:
at least three layers of nonwoven material with each layer having a different color scheme;
one of the layers of nonwoven material having a color scheme based on pigments associated with robin's egg blue;
another layer of nonwoven material having a color scheme based on pigments associated with wisteria violet; and
a third layer of nonwoven material having a color scheme based on pigments associated with seafoam green.

33. The dental facial protection product of claim 30 further comprising:
the first layer of nonwoven material having spunbonded fibers;
the second layer of nonwoven material having meltblown fibers; and
the third layer of nonwoven material having spunbonded fibers.

34. A medical facial protection product formed with at least two layers of nonwoven material comprising:
each layer of nonwoven material having a color scheme formed in part by differentially pigmented fibers or filaments;
at least one of the layers having at least two colors formed by adding differentially pigmented fibers or filaments;
the color scheme formed on one of the layers of nonwoven material different from the color scheme formed on one of the other layers of nonwoven material; and
the color scheme visible from at least a portion of the product.

35. The medical facial protection product of claim 34 further comprising the color scheme formed by varying a nonwoven material characteristic selected from the group consisting of: pigment color, pigment concentration, fiber or filament density, fiber or filament diameter, coverage, spacing and any combinations thereof.

36. The medical facial protection product of claim 34 further comprising at least three layers of nonwoven material with each layer of nonwoven material having a different color scheme.

37. The medical facial protection product of claim 36 further comprising:
the first layer of nonwoven material having spunbonded fibers;
the second layer of nonwoven material having meltblown fibers; and
the third layer of nonwoven material having spunbonded fibers.

38. A nonwoven product comprising:
a first layer and a second layer;
said first layer being adjacent to said second layer;
said second layer forming an outer visible surface of said product;
at least a portion of said first layer having a first color scheme;
at least a portion of said second layer having a second color scheme; said first color scheme being different from said second color scheme;
said second layer being constructed wherein said first color scheme is at least partially visible through at least a portion of said second layer; and said first color scheme cooperating with said second color scheme to produce a third color scheme which is different from said first and second color schemes.

39. A nonwoven product as set forth in claim 38 wherein said second layer comprises a marble appearance due to the combination of said first color and said second color.

40. The nonwoven product of claim 38 selected from the group consisting of facial protection masks, medical and dental face masks, medical respirators and industrial respirators.

41. The nonwoven product of claim 38 selected from the group consisting of medical and dental products including caps, gowns, head covers, shoe covers, surgical drapes, sterilization wraps, ice packs, bandages, wound dressings, medical uniforms, and protective garments worn in surgery.

42. The nonwoven product as set forth in claim 38 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

43. A nonwoven product comprising:
at least first and second layers made from nonwoven materials;
said first and second layers being differentially pigmented wherein said first layer is a first color and said second layer is a second color;
said second layer forming an outer layer of said product wherein said first and second layers cooperate with one another to create a visual image of the combination of said first and second colors.

44. The nonwoven product of claim 43 selected from the group consisting of facial protection masks, medical and dental face masks, medical respirators and industrial respirators.

45. The nonwoven product of claim 43 selected from the group consisting of medical and dental products including caps, gowns, head covers, shoe covers, surgical drapes, sterilization wraps, ice packs, bandages, wound dressings, medical uniforms, and protective garments worn in surgery.

46. The nonwoven product as set forth in claim 43 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

47. A nonwoven product comprising:
an inner layer and an adjacent outer layer;
said inner layer is a first color;
said outer layer is a second color; said first color being different from said second color;
at least a portion of said outer layer being translucent whereby the color of said inner layer is visible through at least a portion of said outer layer.

48. The nonwoven product of claim 47 selected from the group consisting of facial protection masks, medical and dental face masks, medical respirators and industrial respirators.

49. The nonwoven product of claim 47 selected from the group consisting of medical and dental products including caps, gowns, head covers, shoe covers, surgical drapes, sterilization wraps, ice packs, bandages, wound dressings, medical uniforms, and protective garments worn in surgery.

50. The nonwoven product as set forth in claim 47 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

51. A nonwoven product comprising:
an inner layer and an adjacent outer layer;
said inner layer being a different color from the color of said outer layer;
said outer layer being constructed so that the color of said inner layer is visibly discernable through at least a portion of said outer layer; and said first color and said second color cooperate with each other to produce a color scheme when viewed from said outer layer.

52. A nonwoven product as set forth in claim 51 wherein the material which forms said outer layer is substantially non-uniform thereby forming at least one substantially translucent region so that the color of said inner layer is visible through said translucent region of said outer layer.

53. The nonwoven product of claim 51 selected from the group consisting of facial protection masks, medical and dental face masks, medical respirators and industrial respirators.

54. The nonwoven product of claim 51 selected from the group consisting of medical and dental products including caps, gowns, head covers, shoe covers, surgical drapes, sterilization wraps, ice packs, bandages, wound dressings, medical uniforms, and protective garments worn in surgery.

55. The nonwoven product as set forth in claim 51 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

56. A method for forming a nonwoven product comprising:
applying at least a first color to a first material;
depositing said first material on a substrate thereby forming a first layer;
applying a second color to a second material;
depositing said second material on to said first layer thereby forming said second layer;
said first and second layers forming a fabric;
constructing said product from said fabric so that said second layer is the outer layer;
the translucence of said second layer being such that said first layer is visible through at least portions of said second layer.

57. The method of claim 56 wherein at least portions of said second material are deposited on said first layer non-uniformly, thereby forming substantially translucent regions in said second layer.

58. The method of claim 56 wherein said nonwoven product is selected from the group consisting of facial protection masks, medical and dental face masks, medical respirators and industrial respirators.

59. The method of claim 56 wherein said nonwoven product is selected from the group consisting of medical and dental products including caps, gowns, head covers, shoe covers, surgical drapes, sterilization wraps, ice packs, bandages, wound dressings, medical uniforms, and protective garments worn in surgery.

60. The method of claim 56 wherein said nonwoven product is selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

61. A method for forming a nonwoven product comprising:
depositing a first material on a substrate thereby forming a first layer;
applying at least a first color to said first material;
depositing a second material on said first layer thereby forming a second layer;
said first and second layers forming a fabric;
constructing said product from said fabric so that said first layer is the outer layer;
the translucence of said second layer being such that said first color is visible through at least portions of said second layer.

62. The method of claim 61 wherein at least portions of said second material are deposited on said first layer non-uniformly, thereby forming substantially translucent regions in said second layer.

63. The method of claim 61 wherein said nonwoven product is selected from the group consisting of facial protection masks, medical and dental face masks, medical respirators and industrial respirators.

64. The method of claim 61 wherein said nonwoven product is selected from the group consisting of medical and dental products including caps, gowns, head covers, shoe covers, surgical drapes, sterilization wraps, ice packs, bandages, wound dressings, medical uniforms, and protective garments worn in surgery.

65. The method of claim 61 wherein said nonwoven product is selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

66. A nonwoven product comprising:
a first layer made of nonwoven material;
a second layer made of nonwoven material;
said first layer and said second layer being adjacent to one another;
said first layer having a first color;
said second layer having a second color;
at least portions of said first layer being translucent so that said second color is visible through said first layer;
at least portions of said second layer being translucent so that said first color is visible through said second layer.

67. The nonwoven product of claim 66 wherein said first and second layers are substantially non-uniform, whereby translucent regions are formed in said first and second layers.

68. The nonwoven product of claim 66 selected from the group consisting of facial protection masks, medical and dental face masks, medical respirators and industrial respirators.

69. The nonwoven product of claim 66 selected from the group consisting of medical and dental products including caps, gowns, head covers, shoe covers, surgical drapes, sterilization wraps, ice packs, bandages, wound dressings, medical uniforms, and protective garments worn in surgery.

70. The nonwoven product of claim 66 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

71. A nonwoven product comprising:
first, second and third layers each made of nonwoven material;
said second layer sandwiched between said first and third layers;
said first layer having a first color; said second layer having a second color; said third layer having a third color; said first, second and third colors being different colors;
at least a portion of said first layer being translucent and at least a portion of said second layer being translucent whereby said second and third colors are visible through said first layer.

72. The nonwoven product of claim 71 selected from the group consisting of facial protection masks, medical and dental face masks, medical respirators and industrial respirators.

73. The nonwoven product of claim 71 selected from the group consisting of medical and dental products including caps, gowns, head covers, shoe covers, surgical drapes, sterilization wraps, ice packs, bandages, wound dressings, medical uniforms, and protective garments worn in surgery.

74. The nonwoven product as set forth in claim 71 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.

75. A nonwoven product comprising:
first, second and third layers each made of nonwoven materials;
said second layer sandwiched between said first and third layers;
said first layer having a first color; said second layer having a second color; said third layer having a third color; said first and third colors being substantially the same; said second color being different from said first and third colors;
at least a portion of said first layer being translucent and at least a portion of said third layer being translucent whereby said second color is visible through said first layer and said third layer.

76. The nonwoven product of claim 75 selected from the group consisting of facial protection masks, medical and dental face masks, medical respirators and industrial respirators.

77. The nonwoven product of claim 75 selected from the group consisting of medical and dental products including caps, gowns, head covers, shoe covers, surgical drapes, sterilization wraps, ice packs, bandages, wound dressings, medical uniforms, and protective garments worn in surgery.

78. The nonwoven product as set forth in claim 75 selected from the group consisting of agricultural products including crop covers, sacks, ground covers, weed barriers and seed strips; industrial products including equipment covers, filters, uniforms, wrapping materials, vehicle covers, labels, tags, packaging, envelopes, vehicle headliners, wipes for polishing, cleaning and or disinfecting, and padding; home building products including insulation, house wraps, roofing material, wall covering, and floor pads; personal protection equipment including uniforms, hoods, head covers, gowns, shoe covers, vests, chemical suits, biological protection suits, firefighting suits and biohazard suits; and outdoor products including shade coverings, awnings, camouflage materials, and lawn and patio furniture; personal care products including disposable diapers, undergarments, sanitary napkins, tampons, feminine hygiene products and body wipes; and apparel, upholstery backing materials and interlinings.
